(19) United States
(12) Patent Application Publication
(10) Pub. No.: US 2003/0188607 A1
(43) Pub. Date: Oct. 9, 2003

(54) Orientation adjustable spanner

(76) Inventor: Chih-Ching Hsien, Hong-Wen City (TW)

Correspondence Address: Chih-Ching Hsien, 235 Chung - Ho, Box 8-24, Taipei, TW

(21) Appl. No.: 10/118,172

(22) Filed: Apr. 9, 2002

(51) Int. Cl. B25B 23/16

(52) U.S. Cl. 81/177.7

(57) ABSTRACT

A spanner comprises a driving head and a second pivotal portion; the driving head having an engaging portion for engaging screws; and the handle being capable of being held, thereby, the user can apply a force thereon. One end of the driving head has a first pivotal portion and one end of the handle has a second pivotal portion; the first pivotal portion and second pivotal portion are pivotally connectable for adjusting a respective orientation between the driving head and the handle. The holding area of the handle is larger than the prior art and thus the user can apply force to the handle easily. Moreover, the orientation of the handle respective the driving head is adjustable.

### FIELD OF THE INVENTION

The present invention relates to spanners, and particularly to an orientation adjustable spanner.

### BACKGROUND OF THE INVENTION

Spanners are necessary devices for engaging or disengaging screw means. FIGS. 1 to 3 show various types of prior art spanners. These prior art spanners have engaging portions for engaging with screw means. The handles of these spanners have the same structures. This prior art handle has a thin plate-like structure and is connected to the engaging portion with the plate surfaces of the handle being parallel to the plane of the engaging portion. It is often that the user can not hold the spanner conveniently. Moreover, since the two surfaces of the handle having larger area than the other two surfaces of the handle are parallel to the surface of the spanner, the force can not be applied conveniently and effectively.

Referring to FIG. 4, an easily force-applied spanner is illustrated. FIG. 4 shows a spanner with two engaging portions, wherein the middle portion of the handle is bent through 90 degrees. However, this design can not fully dissolve the prior art problems. Although farther section of the handle is vertical to one respective engaging portion, it is often that if the user holds this portion, the user will feel inconveniently. Moreover, the manufacturing work is complicated.

### SUMMARY OF THE INVENTION

Accordingly, the primary object of the present invention is to provide a spanner which can be assembled easily. The time period and labor required are less than the prior art.

Another object of the present invention is to provide a spanner, wherein force can be transferred more accurately. No efficiency loss occurs.

To achieve above object, the present invention provides spanner comprising a driving head and a handle; the driving head having an engaging portion for engaging screws; and the handle being capable of holding, thereby, the user can apply a force thereon. One end of the driving head has a first pivotal portion and one end of the handle has a second pivotal portion; the first pivotal portion and second pivotal portion are pivotally connectable for adjusting a respective orientation between the driving head and the handle.

The various objects and advantages of the present invention will be more readily understood from the following detailed description when read in conjunction with the appended drawing.

### BRIEF DESCRIPTION OF THE DRAWINGS

FIG. 1 is a schematic view of a prior art.

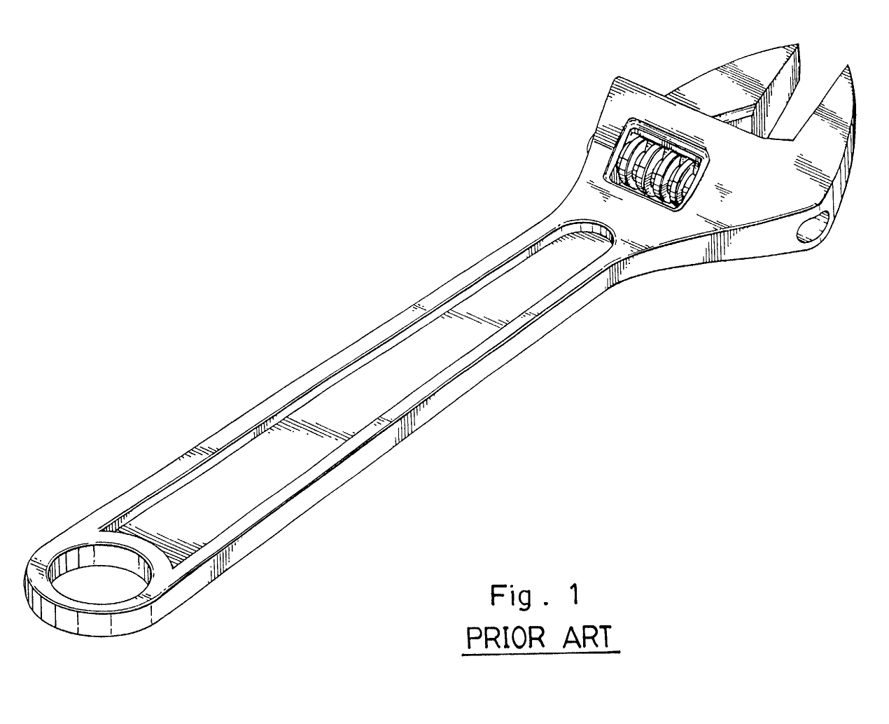

FIG. 2 is a schematic view of another prior art.

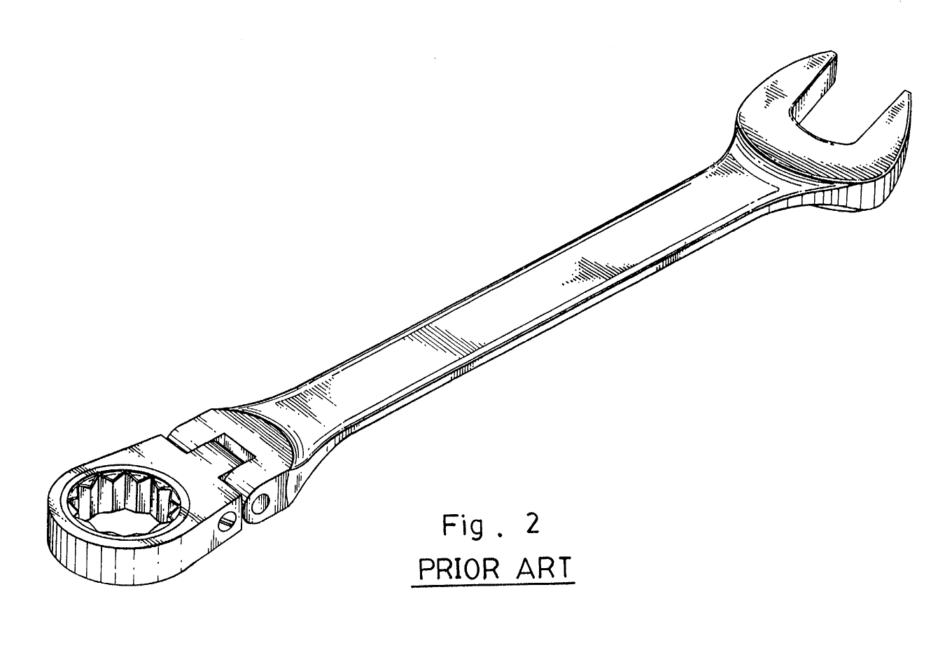

FIG. 3 is a schematic view of a third prior art.

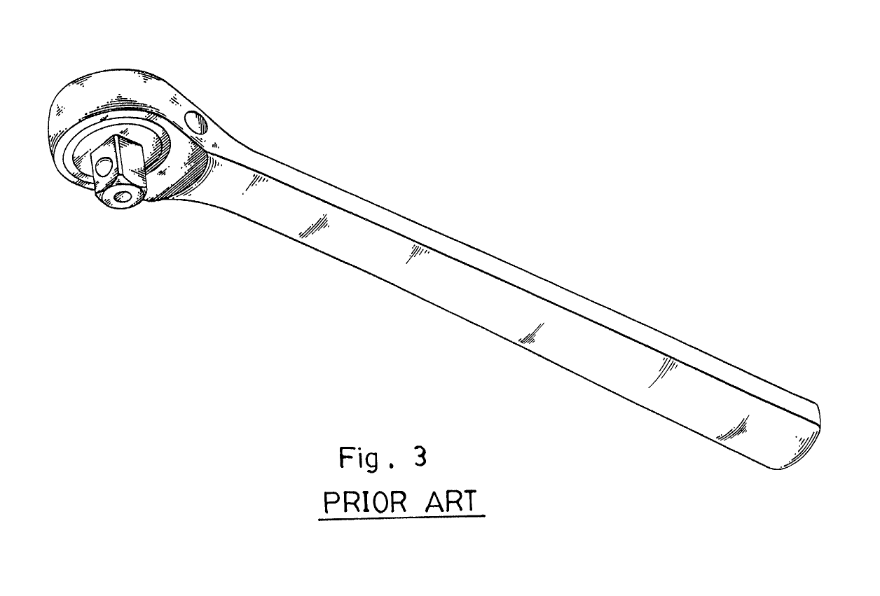

FIG. 4 is a schematic view of a fourth prior art.

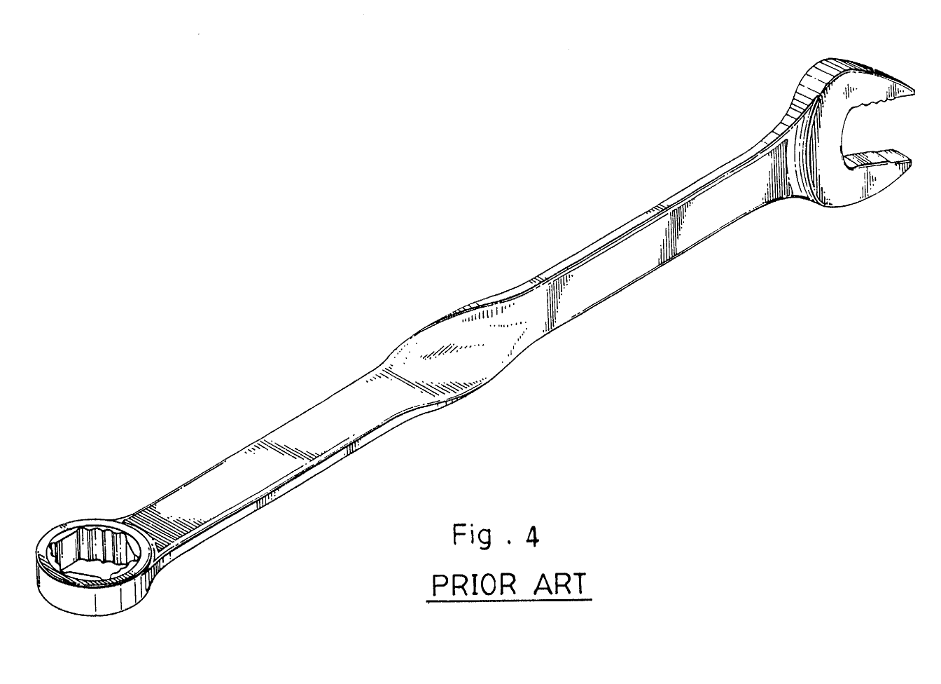

FIG. 5 is an assembled view of the present invention.

FIG. 6 is an exploded perspective view of the present invention.

FIG. 7 is a schematic view showing the orientation adjustment of the present invention.

FIG. 8 is a schematic view showing the holding operation of the present invention.

FIG. 9 is a schematic perspective view of the second embodiment of the present invention.

FIG. 10 is a schematic view showing that the present invention is used to an opened spanner.

FIG. 11 is another schematic perspective view of the opened spanner according to the present invention.

FIG. 12 is a schematic perspective view showing that the present invention is used to a socket spanner.

FIG. 13 is another schematic perspective view of the socket spanner according to the present invention.

### DETAILED DESCRIPTION OF THE PREFERRED EMBODIMENTS

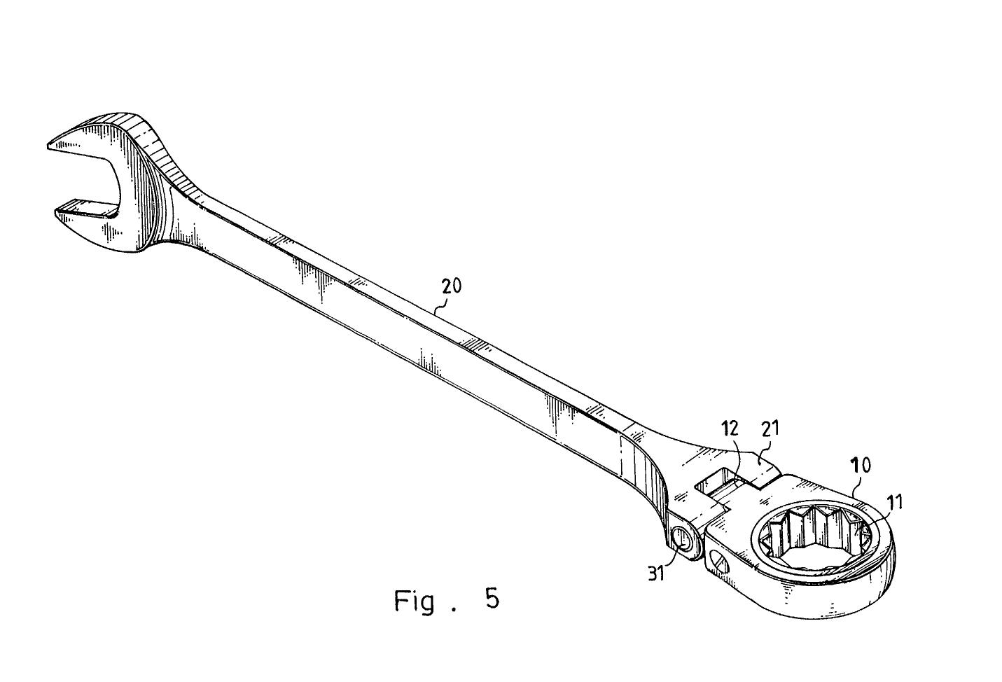

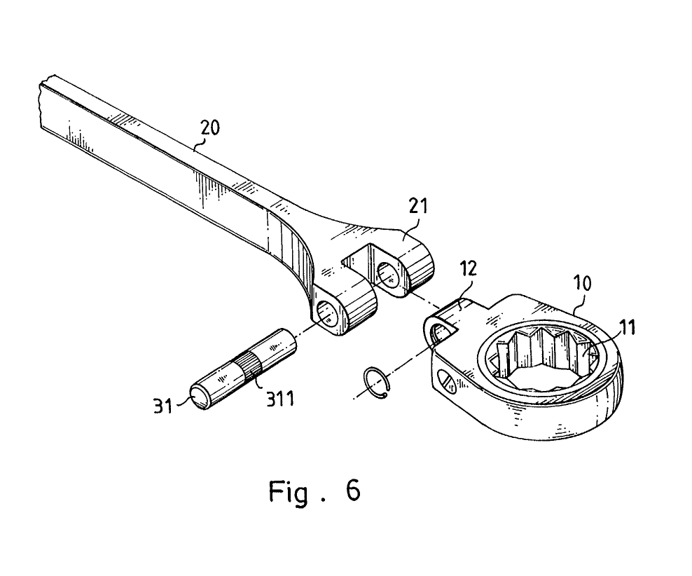

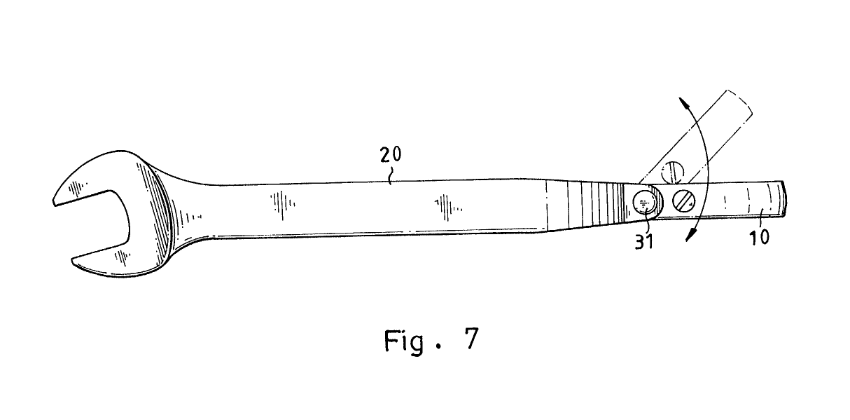

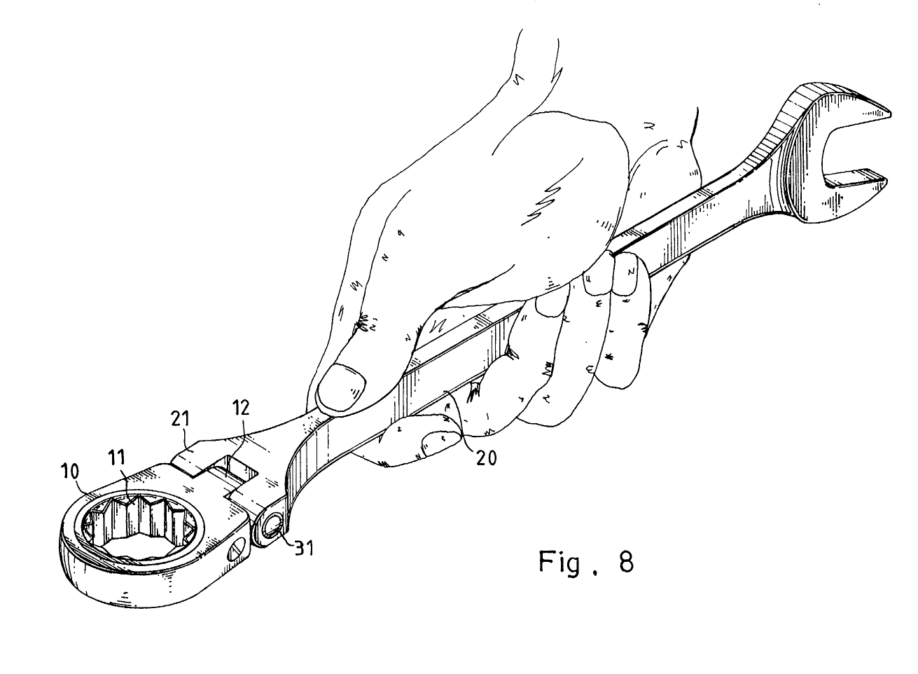

Referring to FIGS. 5 to 8, the spanner of the present invention has a driving head 10 and a handle 20.

The driving head 10 has an approximate elliptic shape. The inner edge of the driving head 10 has an engaging portion 11 for engaging screws. The end with respect to the spanner has a first pivotal portion 12 has an approximate T shape for being pivotally connecting to the handle 20.

The handle 20 is a long means which can be held by hands. One end corresponding to the driving head 10 has an approximate U shape second pivotal portion 21. The first pivotal portion 12 is connected with the second pivotal portion 21 by using a pivotal shaft 31 to pass through the two pivotal portions 21. A ring portion 311 of the pivotal shaft 31 is textured for enhancing the tightening of the connection between the driving head 10 and handle 20. The shaft of the handle 20 has four surfaces. The two parallel surfaces of the handle shaft vertical to the surface of the elliptical shape of the driving head 10.

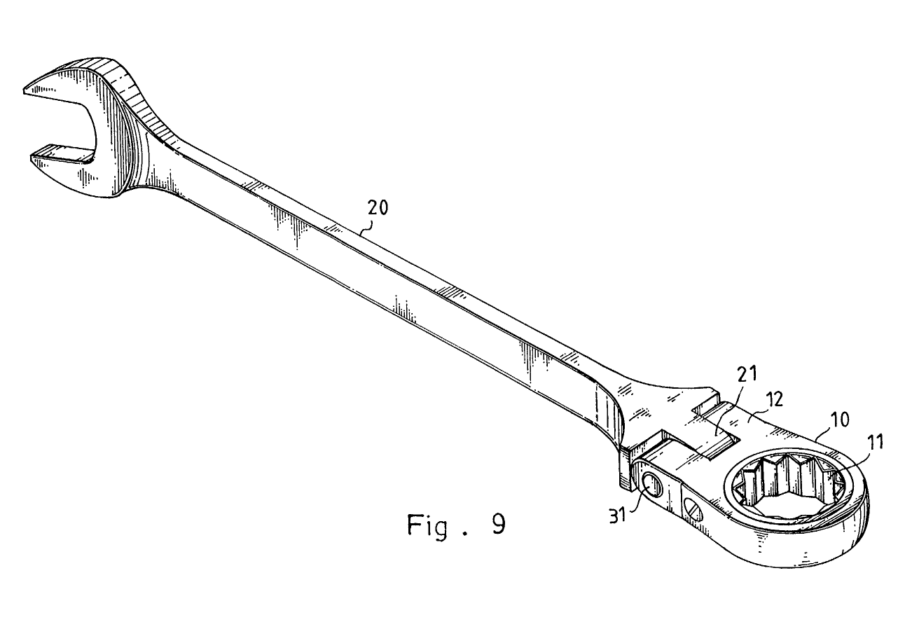

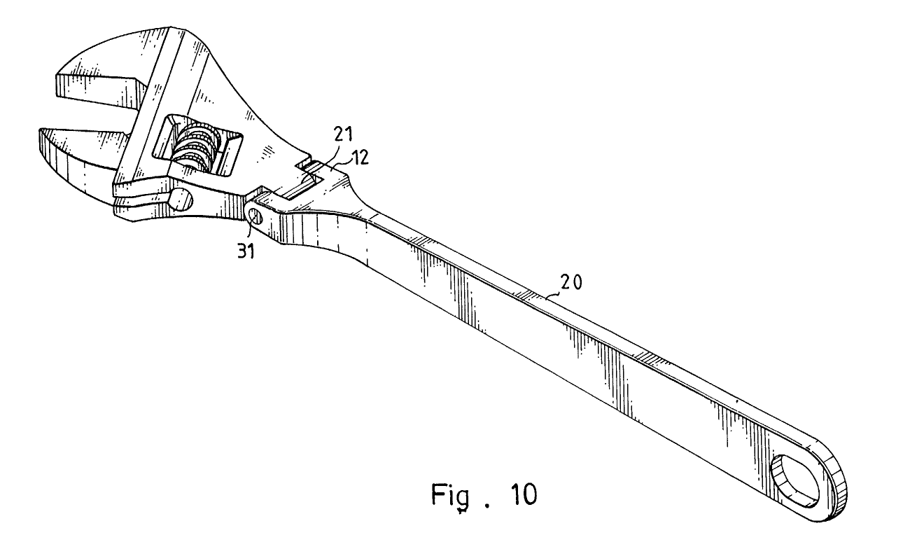

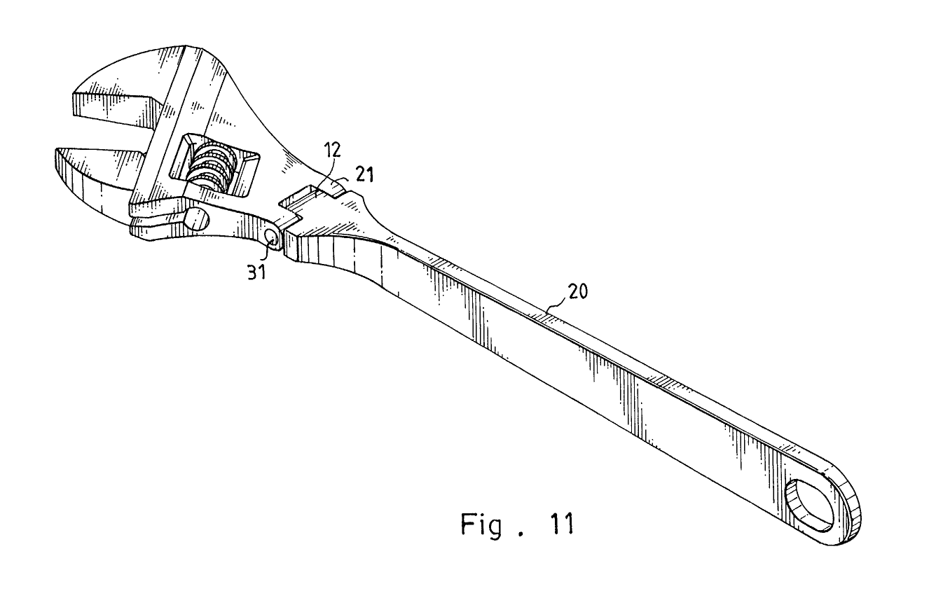

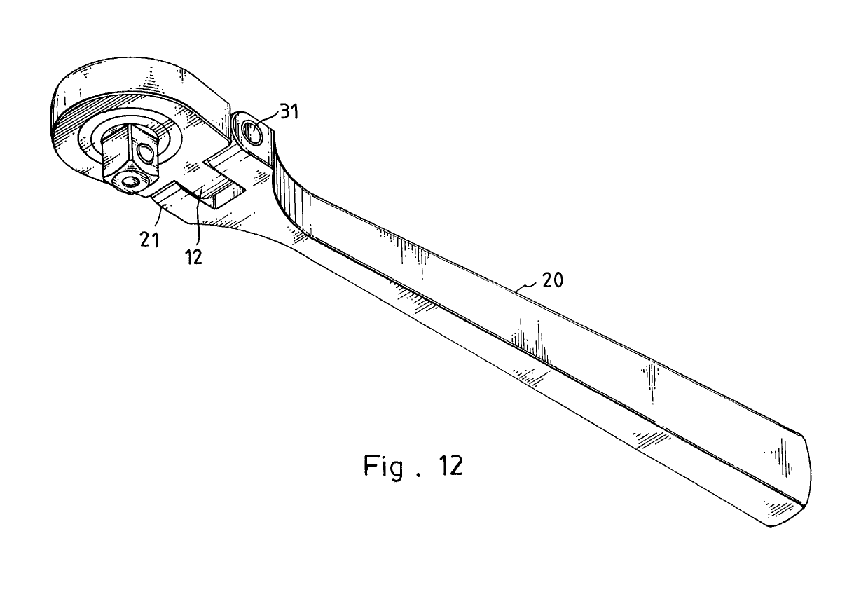

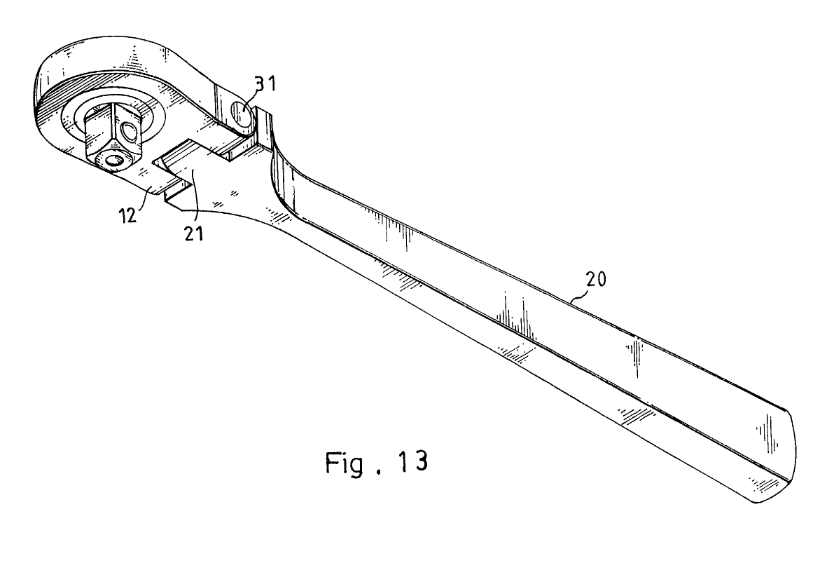

Thereby, since the two parallel surfaces of the handle shaft vertical to the surface of the elliptical shape of the driving head 10. The user's hand has a larger area to contact the handle shaft. The first pivotal portion 12 of the driving head 10 and the second pivotal portion 21 of the handle 20 are connected by the special shapes thereof, the first pivotal portion 12 is pivotally moved to the second pivotal portion 21. The orientation of the handle 20 is changeable. Moreover, since the ring portion 311 of the pivotal shaft 31 is textured for enhancing the tightening of the connection between the driving head 10 and handle 20. Moreover, referring to FIG. 9, the first pivotal portion 12 of the driving head 10 can be designed to be like an approximate U shape and the second pivotal portion 21 of the handle 20 can be designed to be like an approximate T shape. Furthermore, with reference to FIGS. 10 to 13, the connecting way of the present invention can be used to various types of spanners, such as opened spanner, sleeve type spanner, etc.

In summary, the feature of the present invention will be described in the following:

1. The present invention can be assembled easily, in assembly, the first pivotal portion 12 of the driving head 10 is pivotally connected to the second pivotal portion 21 of the handle 20 by using the pivotal shaft 31 to pass through the two pivotal portions 12, 21. The time period and labor required are less than the prior art.

2. It has a preferred structure, no stress is concentrated and no structure is damaged. In the present invention, the second pivotal portion 21 and the handle 20 are formed integrally, and the second pivotal portion 21 is directly pivotally connected to the driving head 10. The force can be transferred more accurately. No efficiency loss occurs.

3. The present invention can be used in many different fields. The holding area of the handle is larger than the prior art and thus the user can apply force to the handle easily. Moreover, the orientation of the handle to the driving head is adjustable.

The present invention are thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A spanner comprising a driving head and a second pivotal portion; the driving head having an engaging portion for engaging screws; and the handle being capable of being held, thereby, the user can apply a force thereon; characterized in that:
one end of the driving head has a first pivotal portion and one end of the handle has a second pivotal portion; the first pivotal portion and second pivotal portion are pivotally connectable for adjusting a respective orientation between the driving head and the handle.

2. The spanner as claimed in claim 1, wherein the driving head and the handle is alternatively arranged.

3. The spanner as claimed in claim 1, wherein the first pivotal portion of the driving head has an approximate U shape and the second pivotal portion of the handle has an approximate T shape.

4. The spanner as claimed in claim 1, wherein the first pivotal portion of the driving head has an approximate T shape and the second pivotal portion of the handle has an approximate U shape.
